(19) United States
(12) Patent Application Publication
(10) Pub. No.: US 2010/0064304 A1
(43) Pub. Date: Mar. 11, 2010

(54) TERMINAL APPARATUS, CHARGING METHOD, AND CHARGING PROGRAM

(75) Inventors: Hiromi Ishizaki, Fujimino-shi (JP); Yasuhiro Takishima, Fujimino-shi (JP)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(73) Assignee: KDDI CORPORATION, Tokyo (JP)

(21) Appl. No.: 12/544,157

(22) Filed: Aug. 19, 2009

(30) Foreign Application Priority Data
Sep. 8, 2008 (JP) P2008-230086

(51) Int. Cl. H04N 7/16

(52) U.S. Cl. 725/5

(57) ABSTRACT

The present invention provides a terminal apparatus that charges an appropriate amount of money according to the usage of individual users without using a network. A terminal apparatus reproduces content in response to a reproduction request from a user. The terminal apparatus includes a charging management unit that charges for the reproduction of the content and stores charging history as history information; a history information database that stores the history information in association with the reproduced content; and a removal determining unit that determines whether to remove the reproduced content from a charging target on the basis of the magnitude relationship between the standard price of the content charged for the reproduction and the sum of charges based on the history information. In this way, it is possible to charge an appropriate amount of money according to the usage of individual users and achieve a user-oriented charging process.

### BACKGROUND OF THE INVENTION

1. Field of the Invention

The present invention relates to a terminal apparatus that reproduces content in response to a reproduction request from a user, and a charging method and a charging program using the same.

2. Description of the Related Art

A charging system has been known which charges for the purchase of content using a network. For example, a charging system has been proposed which manages charging information in a call cost management account when a user purchases content using a mobile phone (see Japanese Patent Application Laid-Open No. 2002-27151).

The charging system requires a flexible charging method corresponding to the usage of the user. In addition, an information processing apparatus has been proposed which enable a user to use content with a discounted price corresponding to the purchase history or usage history of the content (see Japanese Patent Application Laid-Open No. 2001-22843). A content reproducing/charging apparatus has been also proposed which can flexibly correspond to the viewing or listening conditions of a user (see Japanese Patent Application Laid-Open No. 2003-331195).

Further, a content reproducing apparatus has been proposed which does not charge for the download of content, manages the number of times the content is reproduced using a specific device, and charges a fee corresponding to the number of times the content is reproduced (see Japanese Patent Application Laid-Open No. 2005-25559). A deferred payment system has been also proposed which charges the user a fee corresponding to the number of times multimedia is reproduced (see Japanese Patent Application Laid-Open No. 2006-178938). Furthermore, a music reproducing apparatus has been proposed which calculates and charges a fee on the basis of a music playback time (see Japanese Patent Application Laid-Open No. 5-81554).

As described above, the charging system that flexibly charges for the reproduction of content according to the usage of the user has been proposed. For example, the systems disclosed in JP-A Nos. 2001-22843 and 2003-331195 discount the charge on the basis of usage history or flexibly charge for the reproduction of content on the basis of a table. However, this is expensive for the user who purchases content and reproduces the content only one or two times. The systems disclosed in JP-A Nos. 2005-25559, 2006-178938, and 5-81554 charge a fee according the number of times content is reproduced, but there is no upper limit of the fee. Therefore, the user who frequently listens to music is likely to be charged a fee more than the purchase price. In any case, it is difficult to say that a fee suitable for the usage of the user is charged, and fees are not fairly charged to all users.

In all the charging systems, a terminal that reproduces content transmits or receives information to or from a charging apparatus through a network. Therefore, when the system pursues flexible charging according to the usage of the user, the reproduction conditions of content may not be identical to charging conditions. It is necessary to make the conditions of each terminal identical to the charging conditions all the time in order to correspond to the usage of individual users, and it is preferable to perform a charging process without using a network.

### SUMMARY OF THE INVENTION

The invention has been made in order to solve the above-mentioned problems, and an object of the invention is to provide a terminal apparatus, a charging method, and a charging program capable of charging an appropriate amount of money according to the usage of individual users without using a network.

(1) In order to achieve the object, there is provided a terminal apparatus that reproduces content in response to a reproduction request from a user. The terminal apparatus includes: a charging management unit that charges for the reproduction of the content and stores charging history as history information; a history information database that stores the history information in association with the reproduced content; and a removal determining unit that determines whether to remove the reproduced content from a charging target on the basis of the magnitude relationship between the standard price of the content charged for the reproduction and the sum of charges based on the history information.

As such, the terminal apparatus according to the aspect of the invention charges for the reproduction of content, stores the history information, and removes the content from the charging target on the basis of the sum of charges corresponding to the history information. In this case, it is possible to manage the history information in association with the content and charge a fee on the basis of the reproduction history of each user. In this way, it is possible to charge an appropriate amount of money according to the usage of individual users and achieve a user-oriented charging process. The standard price of content is, for example, the price of content when the content is purchased. The sum of charges based on the history information means, for example, the sum of charges corresponding to the number of times the content is reproduced.

(2) The terminal apparatus according to the aspect of the invention may further include a charging target determining unit that determines whether the content requested to be reproduced is the charging target. When it is determined that the content requested to be reproduced is not the charging target, the charging management unit does not charge for the reproduction of the content.

As described above, the reproduction of content other than the charging target is not charged. Therefore, when the sum of charges based on the history information is equal to or more than the standard price of the content, the content can be reproduced free of charge. For example, if a charge when music content is reproduced many times as trials is more than the purchase price, the content can be reproduced free of charge thereafter.

(3) In the terminal apparatus according to the aspect of the invention, the charging management unit may multiply a specific coefficient to calculate a charge for reproducing the content. When it is determined that the content requested to be reproduced is not the charging target, the charging management unit may calculate the charge using the specific coefficient as zero.

In this way, when it is determined that the content requested to be reproduced is not the charging target, the specific coefficient is zero, and the reproduction of the content is free. The specific coefficient may be defined as charging determination information obtained from the determination result of the removal determining unit. In this case, the charge can be calculated by the same method as that when it is determined that the content is the charging target.

(4) The terminal apparatus according to the aspect of the invention may further include: a payment determining unit that determines whether the content requested to be reproduced can be paid for; and a reproduction control unit that controls the reproduction of the content on the basis of the payment determination result. When it is determined that the content requested to be reproduced cannot be paid for, the reproduction control unit does not reproduce the content requested to be reproduced.

In this way, when the content cannot be paid for even though the charging process can be performed, the content is set to be unable to be reproduced. As a result, even when the content is flexibly charged for according to the usage of each user, it is possible to reliably manage the charging conditions and make the charging conditions identical to the reproduction conditions of content.

(5) The terminal apparatus according to the aspect of the invention may further include a payment unit that pays the sum of charges based on the history information. In this way, only the terminal apparatus can be used to calculate the sum of charges and pay the charges. For example, it is possible to pay the charges with electronic money stored in the terminal apparatus.

(6) According to another aspect of the invention, there is provided a charging method of charging for the viewing or listening to content. The charging method includes the steps of: charging for the reproduction of content requested to be reproduced by a user and storing charging history as history information; determining whether to remove the reproduced content from a charging target on the basis of history information that is stored in association with the reproduced content, the magnitude relationship between the standard price of the content charged for the reproduction and the sum of charges based on the history information; and using a terminal apparatus that reproduces the content requested to be reproduced by the user to charge for the reproduction of the content without using a network. In this way, it is possible to charge an appropriate amount of money according to the usage of individual users.

(7) According to still another aspect of the invention, there is provided a charging program for charging for the viewing or listening to content that allows a terminal apparatus which reproduces content requested to be reproduced by a user to perform the processes of: charging for the reproduction of the content requested to be reproduced by the user and storing charging history as history information; and determining whether to remove the reproduced content from a charging target on the basis of history information that is stored in association with the reproduced content, the magnitude relationship between the standard price of the content charged for the reproduction and the sum of charges based on the history information. The terminal apparatus charges for the reproduction of the content without using a network. In this way, it is possible to charge an appropriate amount of money according to the usage of individual users.

### BRIEF DESCRIPTION OF THE DRAWINGS

FIG. 1 is a block diagram illustrating the structure of a terminal apparatus according to an embodiment of the invention; and

FIG. 2 is a flowchart illustrating the characteristic operation of the terminal apparatus according to the embodiment of the invention.

### DETAILED DESCRIPTION OF THE PREFERRED EMBODIMENT

Hereinafter, exemplary embodiments of the invention will be described with reference to the drawings.

(Structure of Terminal Apparatus)

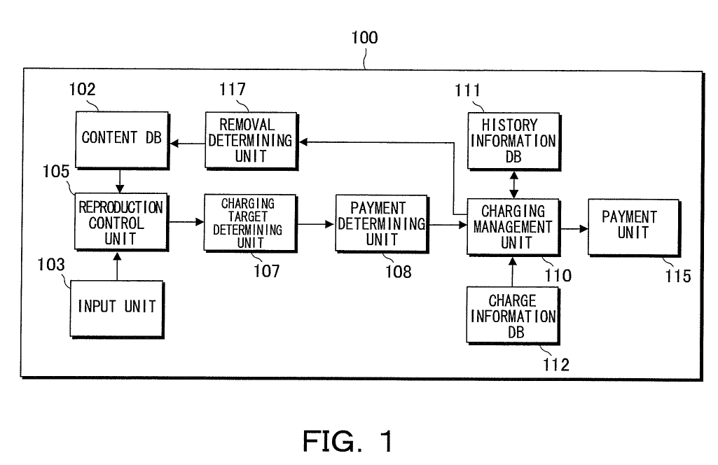

FIG. 1 is a block diagram illustrating the structure of a terminal apparatus 100. The terminal apparatus 100 reproduces content in response to a reproduction request from a user, and is, for example, a mobile phone. The terminal apparatus 100 may be a portable terminal, such as a PDA, or a PC. The content is, for example, music or video. The terminal apparatus 100 has a function of reproducing the content. As shown in FIG. 1, the terminal apparatus 100 includes a content database 102, an input unit 103, a reproduction control unit 105, a charging target determining unit 107, a payment determining unit 108, a charging management unit 110, a history information database 111, a charge information database 112, a payment unit 115, and a removal determining unit 117.

The content database 102 stores content. For example, the content database 102 stores content obtained by a network, such as content distributed by a broadcasting network structure or content downloaded by a download-type network structure. In addition, the content database 102 may store content obtained by an external apparatus as well as the network. Therefore, the user can download content in a trial status, reproduce the content several times at a low fee, and change the state of the content from the trial status to a purchase status.

The content database 102 stores content in association with content identification information, and can read the content on the basis of the content identification information in response to a reproduction request. In addition, the content database 102 may store, for example, meta information related to content. For example, the content database 102 may store charging target information indicating whether content is a charging target as the meta information in association with the content identification information. In addition, most of the content is charged.

The input unit 103 includes, for example, operating keys or a touch panel, and receives a reproduction request from the user. When the user operates the input unit 103 to input a content reproduction request, the reproduction request is transmitted to the reproduction control unit 105.

The reproduction control unit 105 reads content corresponding to the reproduction request from the content database 102, and controls the reproduction of the read content. That is, the charging target determining unit 107 and the payment determining unit 108 perform a necessary determination process on the content read from the content database 102. If it is determined that the content can be reproduced, the reproduction control unit 105 reproduces the content. On the other hand, if it is determined that the content cannot be reproduced, the reproduction control unit 105 does not reproduce the content.

The charging target determining unit 107 determines whether the content requested to be reproduced is a charging target. The charging target determining unit 107 determines charging target information of the content and determines whether to transmit charging determination information to the charging management unit 110 on the basis of the charging target information. As such, the charging target determining unit 107 does not charge for the reproduction of content other than the charging target. Therefore, when the sum of charges based on history information is equal to or more than the standard price of content, the removal determining unit 117, which will be described below, removes the content from the charging target, and the content can be reproduced free of charge. For example, when the sum of charges for reproducing music content many times as trials is more than a purchase price, the music content can be reproduced free of charge thereafter. For example, the standard price of content means the price of content when the content is purchased. In addition, the charging target information may include the header information of content or the meta information stored in the content database.

The payment determining unit 108 determines whether to be able to pay the money charged for the content that is requested to be reproduced. That is, the payment determining unit 108 determines whether the content obtained from the content database 102 can be reproduced. For example, when there is no payment unit corresponding to charges for reproducing the content that is requested to be reproduced, it is determined that the content cannot be reproduced. When electronic money stored in the terminal apparatus 100 is insufficient to pay the charge for the content, it may be determined that the content cannot be reproduced. In this way, the payment determining unit 108 determines whether content can be reproduced on the basis of whether it is possible to pay the charge for the content. When it is impossible to pay the charge for content even though a charging process is available, the content is set to be unable to be reproduced. Therefore, it is possible to manage a reproduction history and charging such that their conditions are coupled to each other. When electronic money is sufficient but the terminal apparatus 100 is out of order or an error occurs therein, the payment determining unit 108 may determine that content cannot be reproduced. As such, the conditions that determine that content cannot be reproduced are not limited to when electronic money is not sufficient to pay the charge for the content, but any other conditions may be set.

The charging management unit 110 calculates a charge for reproducing content, and stores charging history as history information in the history information database 111. However, when it is determined that content requested to be reproduced is not a charging target, the charging management unit 110 does not charge for the reproduction of the content.

For example, the charging management unit 110 can use charging determination information to calculate a charge for the content. When the content requested to be reproduced is a charging target, the charging determination information is set to 1. When the content requested to be reproduced is not a charging target, the charging determination information is set to 0. The charging determination information is used as a specific coefficient that is multiplied according to whether the content requested to be reproduced is a charging target in a charge calculating formula. A specific coefficient is multiplied to calculate a charge for reproducing content. When it is determined that the content requested to be reproduced is not the charging target, the specific coefficient is zero, and the charge for reproducing the content is zero. In addition, the terminal apparatus 100 charges for reproduction, not distribution of content. Therefore, it is not necessary to use a network for the charging process.

The charging management unit 110 reads an amount of money for reproducing the content requested to be reproduced from the charge information database 112, which will be described below, and calculates a charge for reproducing the content on the basis of the charging determination information obtained by the charging target determining unit 107. For example, when the charging determination information (specific coefficient) is N (1 or 0) and the amount of money for reproducing content once is PM, a charge PH for reproducing the content can be calculated as follows: PH=PM×N. In this way, when it is determined that the content requested to be reproduced is not the charging target, the charging determination information is zero, and the reproduction of the content is not charged. In this case, when a charge for reproducing the content is calculated by the same method as that when the content is determined to be the charging target, the charge for reproducing the content is zero.

The charging management unit 110 updates the charging history information of the reproduced content in the history information database 111. For example, when the charging history information is HM, new charging history information HMₙ is updated as follows: HMₙ=HM+PH.

The history information database 111 stores history information in association with the reproduced content. The history information database 111 also stores the charging history information obtained from the charging management unit 110. For example, the history information database 111 stores the sum of charges for reproducing content until now as the charging history information.

The charge information database 112 stores a charge for reproducing content in the content database 102 and the purchase price (standard price) of the content. The charge information database 112 may also store information obtained by, for example, a broadcasting or download type network and information obtained by an external apparatus as well as the network.

The payment unit 115 pays the charge based on the history information or the standard price of the content (for example, the purchase price of the content). The payment unit 115 performs payment on the basis of the charged amount of money obtained by the charging management unit 110. For example, the payment unit 115 performs electronic money payment when the terminal has a credit payment or electronic money function. In this way, it is possible to use only the terminal apparatus 100 to calculate the sum of charges and pay the charges.

The removal determining unit 117 determines whether to remove the content from the charging target on the basis of the magnitude relationship between the standard price of the content requested to be reproduced and the sum of the charges based on the history information. If it is determined to remove the content from the charging target, the header information of the content or the meta information is rewritten to update the charging target information such that the content is removed from the charging target. In this way, the content is removed from the charging target on the basis of the usage of the user. As a result, it is possible to flexibly perform a charging process. In this case, it is preferable that charging history, not reproduction information, be used as the history information to perform the determination. When the determination is performed on the basis of the charging history, the usage of the user is coupled to the charging conditions, and it is possible to reliably determine the amount of money charged to the user.

The removal determining unit 117 compares the charging history information of the content requested to be reproduced which is stored in the history information database 111 with the purchase price of the content which is stored in the charge information database 112. If the sum of the charges specified by the charging history information is equal to or more than the purchase price of the content, the removal determining unit 117 can remove the content from the charging target. This can be achieved by editing, for example, the header information of the content that is requested to be reproduced and stored in the content database 102 or the meta information in the content database 102. For example, when the purchase price of the content is DM, the sum of charges specified by the charging history information is HM, and DM≦HM is satisfied, a process of removing the reproduced content from the charging target is performed. In this embodiment, the removal determining unit 117 determines whether DM≦HM is satisfied. However, the removal determining unit 117 may determine whether DM<HM is satisfied. In any case, the removal determining unit 117 determines whether content is the charging target on the basis of the magnitude relationship between DM and HM. In addition, when the sum of charges HMₙ until content is reproduced n times is less than DM (HMₙ<DM) and the sum of charges HMₙ₊₁ (=HMₙ+PH) until content is reproduced n+1 times is more than DM (DM<HMₙ₊₁), DM may be used as the sum of charges. In this case, the upper limit of the charged amount of money is DM. In addition, PH means an additional charge.

(Operation of Terminal Apparatus)

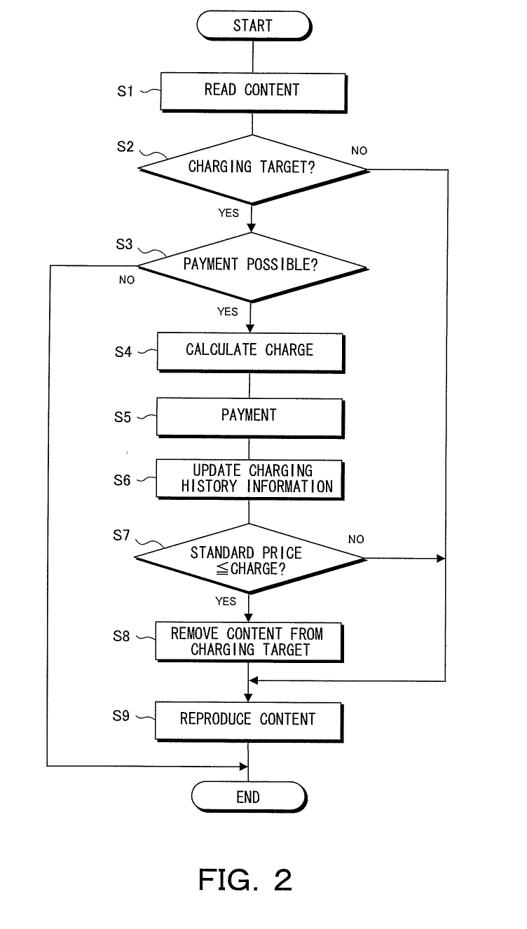

Next, the charging operation of the terminal apparatus 100 when a content reproduction request is received will be described. FIG. 2 is a flowchart illustrating the characteristic operation of the terminal apparatus 100. First, the terminal apparatus 100 reads content requested to be reproduced from the content database 102 (Step S1), and determines whether the read content is a charging target (Step S2). If it is determined that the read content is not the charging target, the terminal apparatus 100 proceeds to Step S9 to reproduce the content.

On the other hand, if it is determined that the read content is the charging target, the terminal apparatus 100 determines whether to be able to pay a charge for reproducing the content (Step S3). If it is determined that the charge cannot be paid, the terminal apparatus 100 ends the process. On the other hand, if it is determined that the charge of the content can be paid, the terminal apparatus 100 calculates a charge for reproducing the content (Step S4), and pays the charge (Step S5).

Then, the terminal apparatus 100 updates the charging history information in the history information database 111 (Step S6). Then, the terminal apparatus 100 determines whether the charge is equal to or more than the standard price (Step S7). If it is determined that the charge is less than the standard price, the terminal apparatus 100 proceeds to Step S9 and reproduces the content. On the other hand, if it is determined that the charge is equal to or more than the standard price, the terminal apparatus 100 removes the content from the charging target (Step S8) and reproduces the content (Step S9). Then, the terminal apparatus 100 ends the process.

As such, the terminal apparatus 100 charges for the reproduction of content, stores history information, and removes the content from the charging target on the basis of the sum of charges corresponding to the history information. In this case, the terminal apparatus 100 may manage the history information in association with content, and perform charging on the basis of the reproduction history of individual users. In this way, it is possible to charge an appropriate amount of money according to the usage of individual users. In the above-described embodiment, the terminal apparatus 100 determines whether content is a charging target and then determined whether a charge for reproducing content can be paid. Alternatively, the terminal apparatus 100 may determine whether a charge for reproducing content can be paid and then determine whether the content is a charging target. In the above-described embodiment, it is assumed that the downloaded content is repeatedly reproduced. However, the invention can be applied to the trial reproduction of content by streaming and the purchase of downloaded content.

What is claimed is:

1. A terminal apparatus that reproduces content in response to a reproduction request from a user, comprising:
a charging management unit that charges for the reproduction of the content and stores charging history as history information;
a history information database that stores the history information in association with the reproduced content; and
a removal determining unit that determines whether to remove the reproduced content from a charging target on the basis of the magnitude relationship between the standard price of the content charged for the reproduction and the sum of charges based on the history information.

2. The terminal apparatus according to claim 1, further comprising:
a charging target determining unit that determines whether the content requested to be reproduced is the charging target,
wherein, when it is determined that the content requested to be reproduced is not the charging target, the charging management unit does not charge for the reproduction of the content.

3. The terminal apparatus according to claim 2,
wherein the charging management unit multiplies a specific coefficient to calculate a charge for reproducing the content, and
when it is determined that the content requested to be reproduced is not the charging target, the charging management unit calculates the charge using the specific coefficient as zero.

4. The terminal apparatus according to claim 1, further comprising:
a payment determining unit that determines whether the content requested to be reproduced can be paid for; and
a reproduction control unit that controls the reproduction of the content on the basis of the payment determination result, wherein, when it is determined that the content requested to be reproduced cannot be paid for, the reproduction control unit does not reproduce the content requested to be reproduced.

5. The terminal apparatus according to claim 1, further comprising:
a payment unit that pays the sum of charges based on the history information.

6. A charging method of charging for the viewing or listening to content, comprising the steps of:
charging for the reproduction of content requested to be reproduced by a user and storing charging history as history information;
determining whether to remove the reproduced content from a charging target on the basis of history information that is stored in association with the reproduced content, the magnitude relationship between the standard price of the content charged for the reproduction and the sum of charges based on the history information; and
using a terminal apparatus that reproduces the content requested to be reproduced by the user to charge for the reproduction of the content without using a network.

7. A charging program for charging for the viewing or listening to content that allows a terminal apparatus which reproduces content requested to be reproduced by a user to perform the processes of:
charging for the reproduction of the content requested to be reproduced by the user and storing charging history as history information; and
determining whether to remove the reproduced content from a charging target on the basis of history information that is stored in association with the reproduced content, the magnitude relationship between the standard price of the content charged for the reproduction and the sum of charges based on the history information,
wherein the terminal apparatus charges for the reproduction of the content without using a network.
